(19) United States
(12) Patent Application Publication
(10) Pub. No.: US 2006/0060597 A1
(43) Pub. Date: Mar. 23, 2006

(54) Device for ejecting blister tablets

(76) Inventor: Gerard Stevens, Huntleys Point (AU)

Correspondence Address: SMITH-HILL AND BEDELL, P.C., 16100 NW CORNELL ROAD, SUITE 220, BEAVERTON, OR, 97006, US

(21) Appl. No.: 10/526,141

(22) PCT Filed: Aug. 19, 2003
(86) PCT No.: PCT/AU03/01047

§ 371 Date: Feb. 28, 2005

(30) Foreign Application Priority Data
Aug. 28, 2002 (AU) 2002951072

(51) Int. Cl. G07F 11/72

(52) U.S. Cl. 221/30

(57) ABSTRACT

A device for dislodging tablets from the interior of a blister comprises a cup having a circular side wall which can be comfortably gripped in the hand. The interior of the cup is provided with a central upward projection which extends above the cup side wall and has its free end shaped to rupture easily a foil backing to the blister so that the tablets can be dislodged from the blister by twisting the cup and fall into the cup from which they are readily recovered.

### FIELD OF THE INVENTION

THIS INVENTION relates to a device for removing tablets from a blister of a blister sheet by way of its foil backing which seals the tablets into the blister.

### STATE OF THE ART

The conventional way of removing tablets from a blister is by depressing the convex face of the blister so that the tablets are forced by finger pressure through the foil backing sheet behind it. Unfortunately the finger pressure which must be exerted on the face of the blister to eject the tablets it contains, may sometimes be excessive for an elderly and possibly frail patient to apply.

### OBJECT OF THE INVENTION

An object of this invention is to provide a device which avoids a patient having to use finger pressure to eject tablets from a blister.

### THE INVENTION

In accordance with the present invention a device for ejecting tablets from a blister of a blister sheet through a foil backing sheet, comprises a cup having a rim which can be placed against the underside of the backing sheet around the position of the blister, and a projection for rupturing the foil and extending upwardly above the rim of the cup in the vicinity of its central portion, the projection being used to strip the foil of the backing sheet away from the underside of the blister so that the tablets fall through the ruptured foil into the cavity of the cup from which they can be retrieved by the patient.

### PREFERRED FEATURES OF THE INVENTION

Preferably the projection is constructed as a blade which can be turned by twisting the cup once the blade has perforated the foil. The turning action strips away the foil from the sides of the blister to leave a large opening through which all the tablets can drop into the cup.

To facilitate the perforation of the foil, the end of the blade is conveniently serrated. The shape and arrangement of the serrations may be varied to accommodate a wide variety of blister sizes and shapes.

### INTRODUCTION TO THE DRAWING

The invention will now be described in more detail, by way of examples,with reference to the accompanying drawing, in which:

### IN THE DRAWINGS

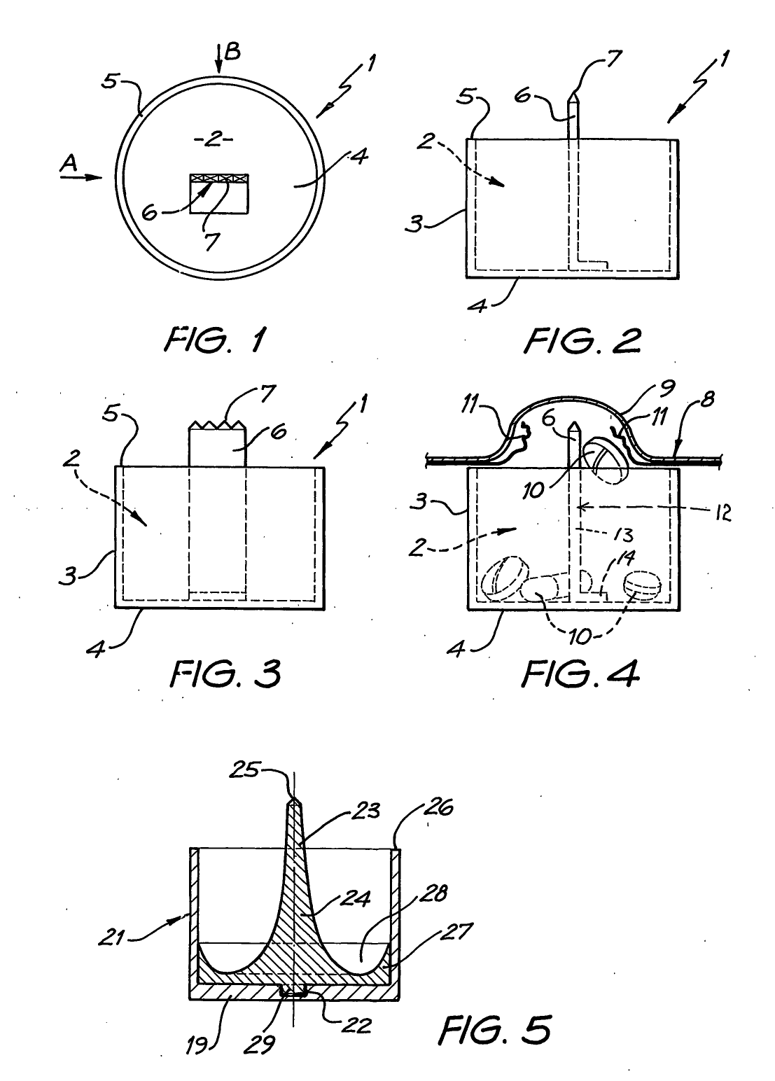

FIG. 1 is a plan view of a device for ejecting tablets from a blister of a blister sheet;

FIGS. 2 and 3 are respectively side views of the device as viewed in the directions of the arrows A and B, respectively, in FIG. 1;

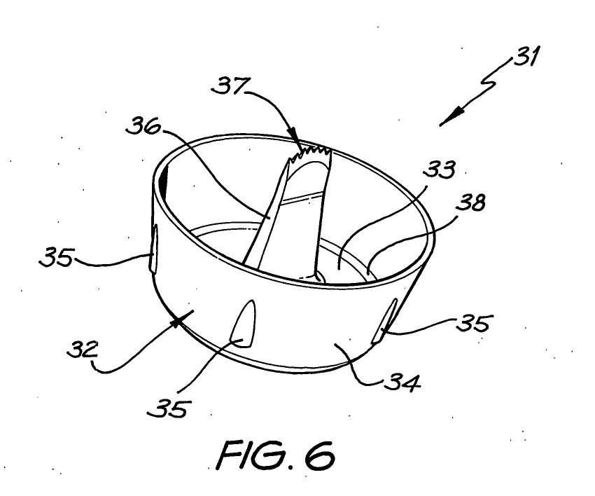

FIG. 4 shows the device in use to dislodge tablets from a blister;

FIG. 5 shows in vertical section an alternative shape of device; and

FIG. 6 is a third embodiment of the device shown in perspective view.

### DESCRIPTION OF FIRST EMBODIMENT

FIGS. 1 and 2 show a device 1 comprising a circular cup 2 made from plastics material and about five centimetres in diameter. The cup 2 has a cylindrical side-wall 3 and a circular base 4. The side wall is about three centimetres high and terminates in a circular rim 5. It will be appreciated that the cup 2 may be oblong instead of circular, to facilitate a manual grip on it by the fingers and hand of the user and to make twisting of it a little easier. been explained with reference to FIG. 4. The body of the stalk 24 is of conical shape and tapers upwardly from an annular portion 27 which is formed around the marginal edge-portion of its upper surface with a moat 28 of U-shaped cross-section and which encircles the root of the stalk 24. The peripheral edge of the annu lar portion 27 fits snugly against the interior wall of the cup 21. A threaded stub shaft 29 projects downwardly from the underside of the annular portion 27 and is screwed into the central threaded opening 22 of the cup 21.

### OPERATION OF A SECOND EMBODIMENT

When the device is in use, the foil backing strip of a blister cavity is perforated by the chevron of the blade which strips away the remainder of the foil sealing the underside of the blister as a result of the manual rotation of the cup. This allows the tablets in the cavity of the blister to drop into the moat 28 of the cup. As the interior of the cup is devoid of sharp corners it can easily be kept clean.

### DESCRIPTION OF THIRD EMBODIMENT

In a third embodiment of the invention shown in FIG. 6 a device 31 is formed as a unitary plastics moulding in the shape of a cup 32 having a circular flat base 33 of 5½ centimetres diameter. The under edge of the base curves upwardly to provide an upwardly divergent annular side wall 34 to the cup. The wall has a height of about 2 3/9 centimetres. Ribs 35 are spaced from one another around the outside of the side wall 34 to facilitate a grip by the hand of the user.

The interior of the cup provides a well 2½ centimetres deep and a round opening of 5½ centimetres diameter.

Centred in the well is an upwardly tapering projection 36 shaped as a blade of rectangular cross-section which projects about 1 centimetre above the cup side wall. The top 37 of the blade is about 14×1 millimetres in cross-section and it has a serrated gently-convex end for assisting its insertion through a foil backing of a blister cavity. All of the inside corner surfaces 38 of the well are rounded and the cup can be easily cleaned in consequence.

As shown in FIGS. 2 and 3, an L-shaped rigid member 12 provides with its longer limb 13 a projection 6 shaped as a blade. The member 12 is attached to the base 4 of the cup by its shorter limb 14. The projection 6 extends upwardly through its central portion for about four-and-a-half centimetres. The upper part of the projection therefore extends about one-and-a-half centimetres above the rim 5 of the cup. This of course may be varied to suit various shapes and depths of blisters. The upper end of the projection is serrated at 7 to provide a line of saw-teeth.

FIG. 4 shows a blister sheet 8 having a blister 9 from which tablets 10 are to be dislodged by the use of the device 1. The opening of the blister 9 is normally sealed by a foil backing sheet 11 which is easily ruptured by the serrated end 7 and which seals the tablets 9 in the cavity of the blister.

### OPERATION OF FIRST EMBODIMENT

To eject the tablets 10 from the blister 9 the cup 2 is raised beneath the underside of the foil backing sheet 11 so that the saw-toothed end 7 of the blade 6 ruptures the sheet 11 and enters the cavity of the blister. Simultaneously the circular rim 5 of the cup is pressed against the underside of the sheet 11 around the marginal under edge of the blister to prevent unwanted escape of the tablets from the cup 2. The cup 2 is then rotated so that the blade 6 inside the blister cavity strips away the foil 11 from the edge of the blister and dislodges the tablets 10 from the blister cavity so that they all fall through the ruptured foil 11 into the cup 2. They can then be retrieved from the cavity of the cup by the patient.

Extraction of the tablets 10 from the cavity of the blister 9 thus takes place easily without risk of any of the tablets being lost or trapped in the blister.

### DESCRIPTION OF SECOND EMBODIMENT

FIG. 5 shows a device made in two parts which are screwed together and which enable cleaning of the device to be carried out easily. The device comprises a polished metal cup 21 having a central threaded opening 22 in its base 19. A projection 23 for removing tablets from a blister is also made of polished metal and has a tapering central stalk 24 terminating at its upper end in a chevron-shaped blade 25 located above the rim 26 of the cup 21 and for rupturing a foil backing sheet of a sealed blister as has already

1-10. (canceled)

11. A device for ejecting tablets from a blister of a blister sheet through a foil backing sheet, comprising a cup having a rim which can be placed against the underside of the backing sheet around the position of the blister, and a projection for rupturing the foil and extending upwardly above the rim of the cup in the vicinity of its central portion, the projection being used to strip the foil of the backing sheet tablets from the underside of the blister so that the tablets fall through the ruptured foil into the cavity of the cup from which they can be retrieved by the patient:

12. A device as set forth in claim 11, in which the projection is constructed as an upwardly directed blade.

13. A device as set forth in claim 11, in which the upper end of the blade is serrated to assist rupturing of the foil.

14. A device as set forth in claim 11, constructed as a one-piece plastic molding.

15. A device as set forth in claim 11, in which the corner regions in the interior of the well are rounded to facilitate its cleaning.

16. A device as set forth in claim 11, in which the projection tapers progressively in cross-section towards it free end.

17. A device as set forth in claim 11, in which the cup is of circular cross-section and the projection is of rectangular cross-section.

18. A device as set forth in claim 11, in which the side wall of the cup is gently upwardly divergent.

19. A device as set forth in claim 11, in which the mouth of the cup is between five and six centimeters in diameter, the height of the cup wall interior is about 2.75 centimeters, and the projection extends about one centimeter above the cup well.

20. A device as set forth in claim 11, in which the upper end of the projection is convex.
